(19) United States
(12) Patent Application Publication
(10) Pub. No.: US 2014/0287631 A1
(43) Pub. Date: Sep. 25, 2014

(54) CONNECTOR AND MANUFACTURING METHOD THEREOF

(71) Applicant: YAZAKI CORPORATION, Tokyo (JP)

(72) Inventors: Harunori Tashiro, Shizuoka (JP); Tomoharu Suzuki, Shizuoka (JP); Ayumu Ishikawa, Shizuoka (JP)

(21) Appl. No.: 14/297,789

(22) Filed: Jun. 6, 2014

Related U.S. Application Data
(63) Continuation of application No. PCT/JP2012/007821, filed on Dec. 6, 2012.

(30) Foreign Application Priority Data
Dec. 8, 2011 (JP) 2011-269164

(51) Int. Cl. H01R 13/428; H01R 43/20

(52) U.S. Cl. CPC H01R 13/428; H01R 43/20
USPC 439/733.1; 29/876

(57) ABSTRACT

An object is to provide a connector which prevents formation of air hole in a filler to improve airtightness in a terminal receiving chamber and increases injection speed of the molten filler to improve manufacturing efficiency. The connector includes a terminal clamp connected with an electric wire and a housing receiving the terminal clamp and the electric wire and having a box-like terminal receiving chamber filled with a filler and having an opening, a bottom face facing the opening and a first side face continued from the bottom face toward the opening. A slanted face is provided at intersection of the bottom face and the first side face and slanted away from the first side face toward the bottom face, and a gap is formed between the terminal clamp and the first side face, the slanted face and the bottom face.

### TECHNICAL FIELD

The present invention relates to a connector and a manufacturing method of the connector, the connector including a terminal clamp arranged to connect with an electric wire and a housing having a terminal receiving chamber arranged to receive the terminal clamp and the electric wire and filled with a filler.

### BACKGROUND ART

An automobile as a moving body is mounted with various electronic devices. A wire harness is used to transmit electric power and a control signal, for example, to these electronic devices. The wire harness includes a plurality of electric wires and connectors. As shown in FIGS. 8 and 9, the connector includes a terminal clamp 102 arranged to connect with an end of an electric wire 10, a housing 103 having a terminal receiving chamber 104 arranged to receive the terminal clamp 102, in which the terminal receiving chamber 104 is filled with a filler while the terminal clamp 102 is received in the terminal receiving chamber 104, and a rear holder 105 arranged to attach to the housing 103 (refer to Patent Literature 1, for example).

The terminal clamp 102 includes an electric wire connection portion 121 arranged to connect with a one end of the electric wire 10 and an electric contact portion 122 arranged to connect with a mating terminal clamp (not shown). The terminal clamp 102 includes a bent portion 123 located between the electric wire connection portion 121 and the electric contact portion 122 so the terminal clamp 102 is bent at the bent portion 123.

The terminal receiving chamber 104 is formed into a box-like shape having an opening 104a. The terminal receiving chamber 104 includes a rectangular bottom face 141 located on the opposite side of the opening 104a, a pair of side faces 142 formed continuously from both edges of the bottom face 141 toward the opening, and an upper face 143 formed continuously from the bottom face 141 and connecting the pair of side faces 142 to each other. A lead-out opening is provided on the opposite side of the upper face 143, i.e. provided in a direction (i.e. an arrowed Y direction) which intersects with an opposing direction of the pair of side faces 142. The other end side of the electric wire 10 is lead out from the lead-out opening to outside of the terminal receiving chamber 104. The opening 104a is covered with a plate portion 151 (described later) of the rear holder 105. On an outer face of the upper 143, there is provided a lock projection 144. This lock projection 144 is arranged to engage with a lock arm 156 (described later) of the rear holder 105.

The rear holder 105 includes the plate portion 151, a boss portion for terminal 153 arranged to abut on the terminal clamp 102 between the bent portion 123 and the electric wire connection portion 121, a boss portion for connection 154 arranged to abut on the electric wire connection portion 121, a boss portion for electric wire 155 arranged to abut on the electric wire 10, and a lock arm 156 arranged to engage with the lock projection of the terminal receiving chamber 104. The rear holder 105 is attached to the terminal receiving chamber 104 by engaging the lock arm 156 with the lock projection 144 of the terminal receiving chamber 104. The rear holder 105 is arranged such that, at this time, the boss portion for electric wire 155 closes a gap between the terminal receiving chamber 104 and the electric wire 10 at the lead-out opening of the terminal receiving chamber 104, and the plate portion 151 covers the opening 104a of the terminal receiving chamber 104. Furthermore, the rear holder 105 includes a plurality of injection openings 105a for injecting a liquid silicone 108 as a filler in molten state in the terminal receiving chamber 104.

A conventional connector 101 having the above-described structure is arranged such that, with the terminal clamp 102 connected to the electric wire 10, an end of the terminal clamp 102 on the side of the electric contact portion 122 is passed through a through-hole (not shown) formed at the bottom face 141 of the terminal receiving chamber 104 so the terminal clamp 102 and the electric wire 10 are received in the terminal receiving chamber 104. Then, the rear holder 105 is attached to the terminal receiving portion 104 by engaging the lock arm 156 of the rear holder 105 with the lock projection 144 of the terminal receiving chamber 104. Then, in this state, the liquid silicone 108 is injected into the terminal receiving chamber 104 from a plurality of injection holes 105a formed on the rear holder 105 to fill the terminal receiving chamber 104 with the liquid silicone 108.

### CITATION LIST

### Patent Literature

[Patent Literature 1] Japan Patent Application Publication No. 2004-349026

### SUMMARY OF INVENTION

### Technical Problem

However, the above-described conventional connector 101 has a drawback that, when the liquid silicone 108 is injected toward a surface of the terminal clamp 102 on the side of the rear holder 105, the liquid silicone 108 closes from both sides a passage along the arrowed Y direction which connects the lead-out opening and the upper face 143 of the terminal receiving chamber 104 and which is located in a gap between the terminal clamp 102 and the pair of side faces 142 of the terminal receiving chamber 104. Thus, the air is captured between the terminal clamp 102 and the respective side faces 142, causing formation of an air hole inside of the liquid silicone 108. Thus, the liquid silicone 108 is hardened with the air hole (i.e. the air bubble) existing inside of the liquid silicone 108, possibly causing a reduction in the airtightness in the terminal receiving chamber 104. Therefore, the speed of injection of the liquid silicone 108 is reduced to buy time to discharge the air from between the terminal clamp 102 and the respective side faces 142. However, when the speed of injection of the liquid silicone 108 is reduced, it requires long time to fill the terminal receiving chamber 104 with the liquid silicone 108, causing a reduction in efficiency of manufacturing of the connector. In other words, it is difficult to improve both of the efficiency of manufacturing of the connector 101 and the airtightness in the terminal receiving chamber 104.

Thus, an object of the present invention is to provide a connector which can prevent formation of an air hole in a filler and improve the airtightness in the terminal receiving chamber, and which can improve the manufacturing efficiency by increasing the speed of injection of the filler in molten state.

### Solution to Problem

The present invention provides, in a first aspect, connector including a terminal clamp arranged to connect with an electric wire, and a housing arranged to receive the terminal clamp and the electric wire and including a box-like terminal receiving chamber having an opening, the terminal receiving chamber being filled with a filler, wherein the terminal receiving chamber includes a bottom face located on opposite side of the opening and a first side face formed continuously from the bottom face toward the opening, a slanted face is provided at an intersection of the bottom face and the first side face, the slanted face being slanted toward a direction further away from the first side face as extended toward the bottom face, and a gap is formed between the terminal clamp and the first side face, the slanted face and the bottom face.

According to the above-described structure, the slanted face which is slanted in a direction further away from the first side face as extended toward the bottom face is provided at the intersection of the bottom face and the first side face, and the gap is formed between the terminal clamp and the first side face, the slanted face and the bottom face. Thus, a passage through which the filler in molten state is injected is created between the terminal clamp and the terminal receiving chamber. Thus, the filler in molten state is injected from the opening of the terminal receiving chamber toward the slanted face, and the filler in molten state can be injected smoothly through the passage into the gap between the terminal clamp and the first side face, the slanted face and the bottom face.

The present invention provides, in a second aspect, the connector according to the first aspect, wherein the terminal receiving chamber includes a second side face located on opposite side of the first side face and formed continuously from the bottom face toward the opening, and a gap is formed between the terminal clamp and the second side face.

According to the above-described structure, the gap is formed between the terminal clamp and the first side face, the slanted face, the bottom face and the second side face of the terminal receiving chamber. Thus, a passage through which the filler in molten state is injected is created between the terminal clamp and the terminal receiving chamber. Thus, the filler in molten state is injected from the opening of the terminal receiving chamber toward the slanted face, and the filler in molten state can be injected through the passage and push the air existing in the gap between the terminal clamp and the first side face, the slanted face and the bottom face out from the gap between the terminal clamp and the second side face.

The present invention provides, in a third aspect, the connector according to the first aspect or the second aspect, wherein the terminal clamp includes an electric wire connection portion arranged to connect with an one end of the electric wire and an electric contact portion arranged to connect with a mating terminal clamp, the electric contact portion being bent at a portion between the electric wire connection portion and the electric contact portion, wherein the terminal receiving chamber includes a through-hole formed on the bottom face for passing the electric contact portion through the through-hole, and a lead-out opening provided in a direction intersecting with an opposing direction of the first side face and the second side face to lead out the other end side of the electric wire, and wherein the connector includes a rear holder attached from the side of the opening of the terminal receiving chamber to close a gap between the lead-out opening and the electric wire.

According to the above-described structure, the rear holder can close the gap between the lead-out opening of the terminal receiving chamber and the electric wire, thereby preventing the filler in molten state from leaking out from the terminal receiving chamber.

The present invention provides, in a forth aspect, the connector according to any one of the first aspect through the third aspect, wherein a corner of the terminal clamp located on opposite side of the slanted face is chamfered.

According to the above-described structure, the corner of the terminal clamp located on the opposite side of the slanted face is chamfered. Thus, the distance between the corner of the terminal clamp and the slanted face is ensured, and thus the filler in molten state can be injected unimpededly in the gap between the terminal clamp and the terminal receiving chamber.

The present invention provides, in a fifth aspect, a method for manufacturing the connector according to any one of the first aspect through the forth aspect, the method including a step of injecting the filler in a molten state from the opening toward the slanted face.

According to the above-described method, the slanted face which is slanted toward a direction further away from the first side face as extended toward the bottom face is provided at the intersection of the bottom face and the first side face, and the gap is formed between the terminal clamp and the terminal receiving chamber. Thus, a passage through which the filler in molten state is injected is created between the terminal clamp and the first side face, the slanted face and the bottom face. Thus, the filler in molten state is injected from the opening of the terminal receiving chamber toward the slanted face, and the filler in molten state can be injected through the passage in the gap between the terminal clamp and the first side face, the slanted face and the bottom face.

### Advantageous Effects of Invention

According to the first and the fifth aspect of the present invention, the filler in molten state is injected from the opening of the terminal receiving chamber toward the slanted face, and the filler in molten state is injected through the passage into the gap between the terminal clamp and the first side face, the slanted face and the bottom face. Thus, no air is left in the gap between the terminal clamp and the bottom face. Thus, the formation of the air hole due to the air left in the filler in molten state can be prevented, thereby improving the airtightness in the terminal receiving chamber. Also, since there is no need to buy time to discharge the air existing in the gap between the terminal clamp and the terminal receiving chamber, the speed of injection of the filler in molten state can be increased, thereby improving the manufacturing efficiency.

According to the second aspect of the present invention, the filler in molten state is injected through the passage into the gap between the terminal clamp and the terminal receiving chamber while pushing the air existing in the gap between the terminal clamp and the first side face, the slanted face and the bottom face out from the gap between the terminal clamp and the second side face. Thus, the speed of injection of the filler in molten state can be increased even more, thereby further improving the manufacturing efficiency.

According to the third aspect of the present invention, by using a simple means, i.e. attaching the rear holder from the side of the opening of the terminal receiving chamber, the gap between the lead-out opening of the terminal receiving chamber and the electric wire can be closed with the rear holder, thereby preventing the filler in molten state to leak out from the terminal receiving chamber.

According to the forth aspect of the present invention, the distance between the corner of the terminal clamp and the slanted face can be ensured. Thus, the filler in molten state can smoothly flow between the terminal clamp and the slanted face in an unimpeded fashion, thereby further improving the speed of injection of the filler in molten state. Thus, the manufacturing efficiency can be improved even more.

### BRIEF DESCRIPTION OF DRAWINGS

FIG. 1 is a perspective view of a connector according to one embodiment of the present invention;

FIG. 2 is a cross-sectional view of the connector shown in FIG. 1 taken along a I-I line;

FIG. 3 is an exploded perspective view of the connector shown in FIG. 1;

FIG. 4 is a perspective view of a housing of the connector shown in FIG. 1;

FIG. 5 is a perspective view showing nozzles for injecting a filler in molten state being moved toward inside of a terminal receiving chamber of the housing shown in FIG. 4;

FIG. 6 is a cross-sectional view of the connector shown in FIG. 5 taken along a II-II line;

FIG. 7 is a perspective view showing injection of the filler in molten state into the terminal receiving chamber of the housing shown in FIG. 4;

FIG. 8 is an exploded perspective view of a conventional connector; and

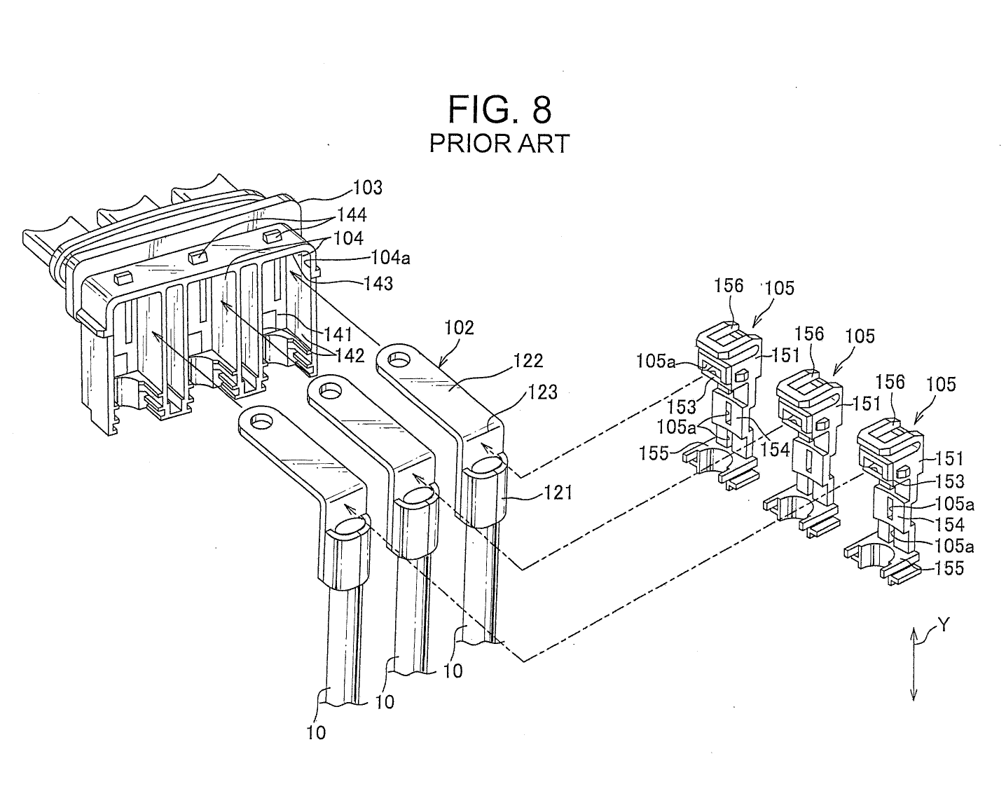

FIG. 9 is a cross-sectional view of the connector shown in FIG. 8.

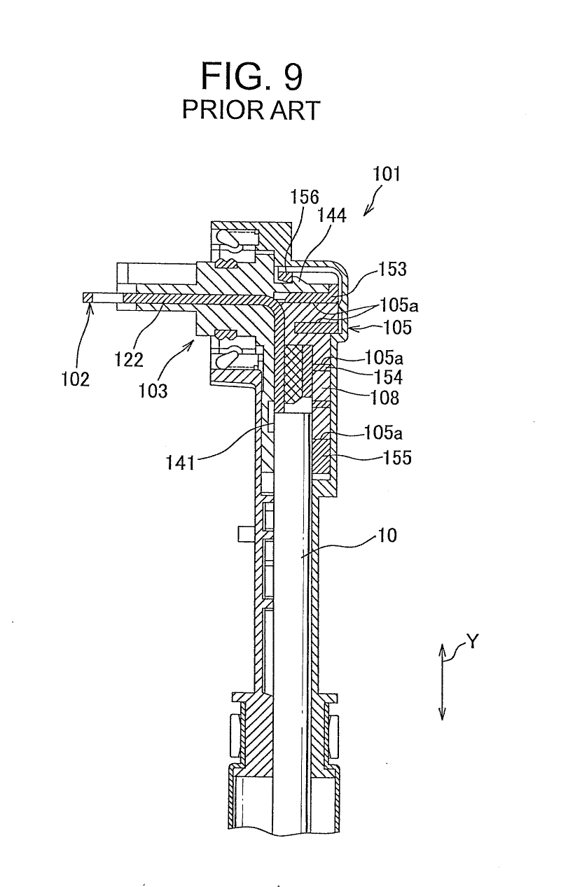

### DESCRIPTION OF EMBODIMENTS

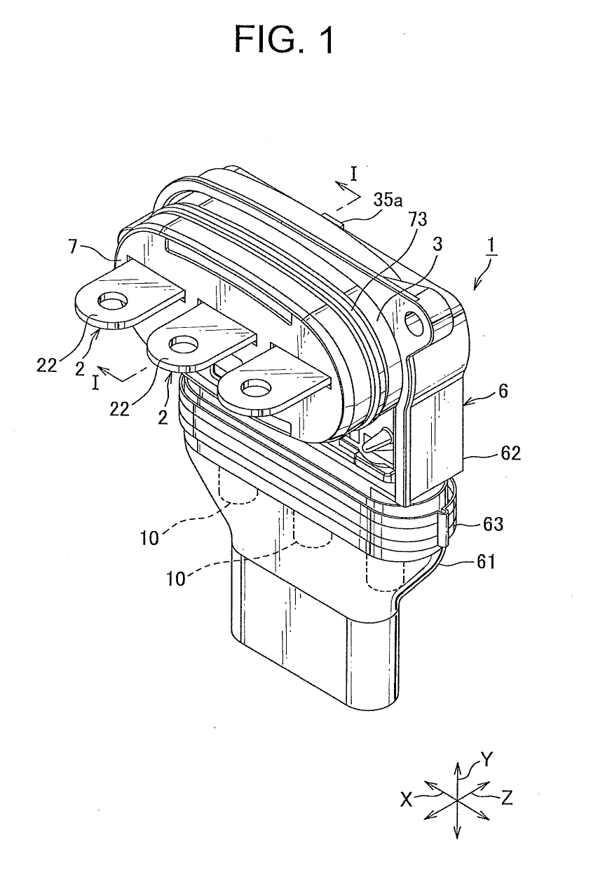

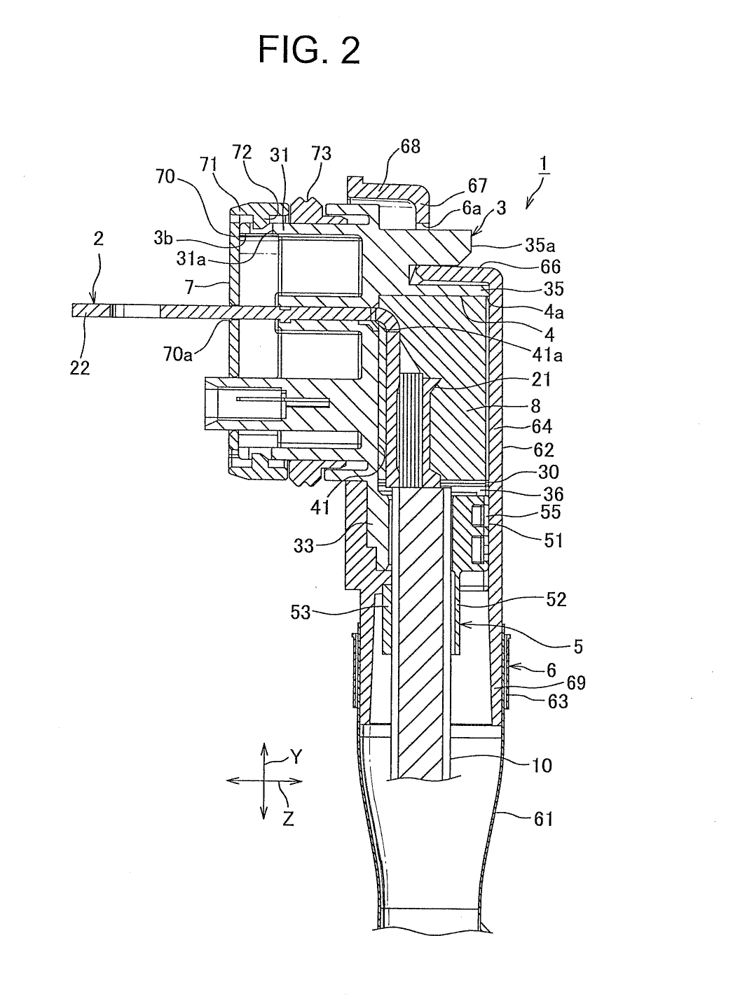

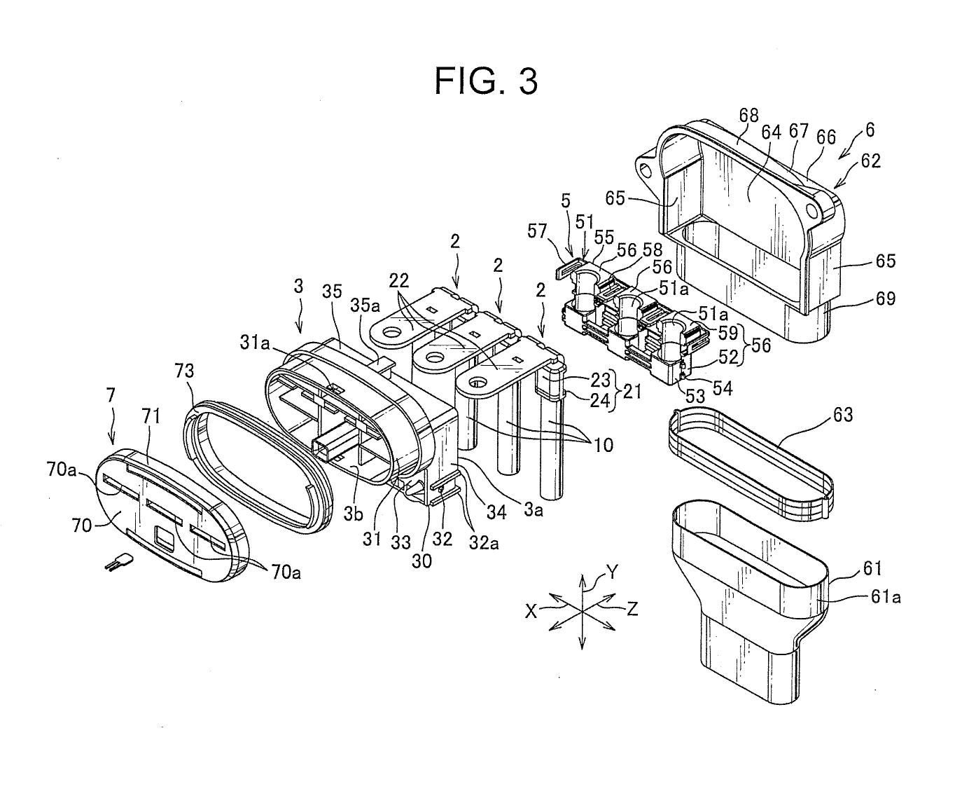

In the following, a connector according to one embodiment of the present invention is explained in reference to FIGS. 1 through 7. A connector 1 constitutes a wire harness to be wired in an automobile, for example. As shown in FIGS. 1 and 2, the connector 1 includes three terminal clamps 2 arranged to connect with ends of electric wires 10 which constitute the wire harness, a housing 3 having three terminal receiving chambers 4 arranged to receive the three terminal clamps 2 and having openings 3a, 3b (shown in FIG. 3) located on one and the other side of the housing 3, a rear holder 5 arranged to be attached to an end of the housing 3, a shield body 6 arranged to cover the opening 3a on one side of the housing 3, and a front holder 7 arranged to cover the opening 3b on the other side of the housing 3.

Herein, an arrowed X direction in FIG. 1 indicates a direction of alignment of the terminal receiving chambers 4 as well as a radial direction of the electric wire 10, an arrowed Y direction indicates a longitudinal direction of the electric wire 10, and an arrowed Z direction indicates a direction which intersects with both of the X direction and the Y direction.

The terminal clamp 2 is obtained by bending a conductive metal plate. Furthermore, as shown in FIGS. 2 and 3, the terminal clamp 2 includes an electric wire connection portion 21 arranged to connect with the electric wire 10 and an electric contact portion 22 formed continuously from the electric wire connection portion 21 and arranged to connect with a mating terminal clamp 2. This terminal clamp 2 is bent between the electric wire connection portion 21 and the electric contact portion 22 and is formed into an L-shape.

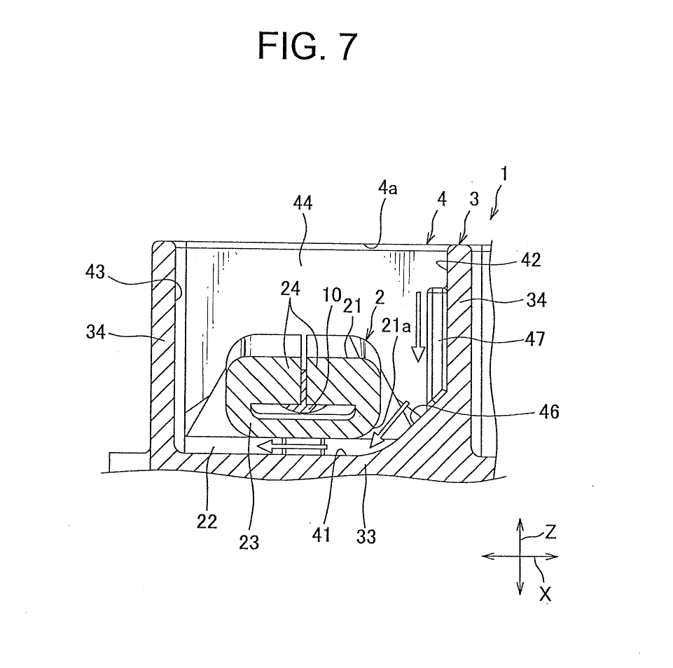

The electric wire connection portion 21 includes a rectangular base wall 23 arranged to position the electric wire 10 on a surface of the base wall 23 and a pair of crimp pieces 24 extending perpendicularly from both widthwise ends of the base wall 23 for pressure bonding a core wire of the electric wire 10. Furthermore, as shown in FIG. 7, the terminal clamp 2 includes an R portion 21a (i.e. a curved face) formed by chamfering a corner of the terminal clamp 2 located on the opposite side of a slanted face 46 (described later) of the terminal receiving chamber 4, i.e., the corner between the base wall 23 and the crimp piece 24. Alternatively, the corner of the terminal clamp 2 between the base wall 23 and the crimp piece 24 may be chamfered and formed into a flat shape.

The electric wire 10, which has a circular cross section and has an end stripped so as to expose a core wire, is disposed on the base wall 23, and then the crimp pieces 24 are bent in a direction in which the core wire portion of this electric wire 10 is pushed against the base wall 23, i.e. the crimp pieces 24 are crimped around the core wire portion of the electric wire 10, thereby electrically-connecting the electric wire connection portion 21 with the electric wire 10.

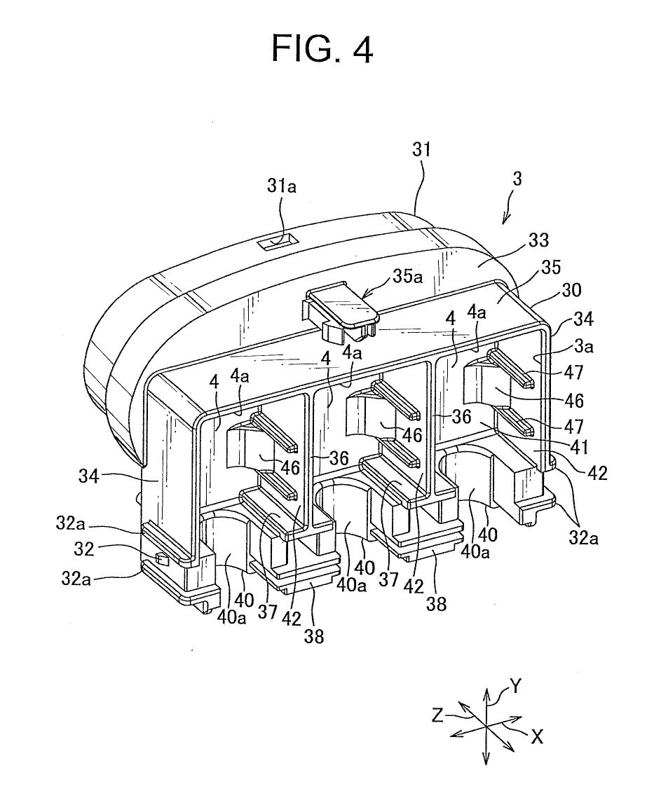

The housing 3 is made of insulating synthetic resin. As shown in FIG. 4, the housing 3 includes a substantially-rectangular shaped bottom wall 33, a first receiving portion 30 provided on one side of the bottom wall 33 in the Z direction and having the three terminal receiving chambers 4 arranged to receive the electric wire connection portions 21 of the respective three terminal clamps 2, and a second receiving portion 31 provided on the other side of the bottom wall 33 in the Z direction and arranged to receive the electric contact portions 22 of the three terminal clamps 2.

The first receiving portion 30 is formed into a quadrangular tube-like shape having the opening 3a on one side of the first receiving portion 30, as shown in FIG. 4. This first receiving portion 30 includes a pair of side walls 34 extending perpendicularly from both ends in a longitudinal direction (i.e. the X direction) of the bottom wall 33, an upper wall 35 connecting the pair of side walls 34 and extending perpendicularly from the bottom wall 33, two partition plates 36 provided between the pair of side walls 34 to divide the first receiving portion 30 into three terminal receiving chambers 4 in the X direction and formed shorter than the dimension of the side wall 34 in the Y direction, two inner walls 37 formed continuously from both of the bottom wall 33 and the respective partition walls 36 and arranged on the opposite side of the upper wall 35, and lower walls 38 arranged on the opposite side of the respective inner walls 37 and extending perpendicularly from an edge on the other side of the bottom wall 33.

The bottom wall 33 includes a fitting portion 35a arranged to be fitted in an engaged fashion in a fitting hole 6a (described later) of the shield body 6. This fitting portion 35a is provided on the one side of the bottom wall 33 located above the upper wall 35 of the first receiving portion 30.

The pair of side walls 34 includes an engagement portion 32 arranged to engage with a first lock arm 57 (described later) of the rear holder 5. This engagement portion 32 is provided on an outer face of the respective side walls 34 of the first receiving portion 30 at an end of the side walls 34 distant from the upper wall 35. A pair of ribs 32a is provided on both sides of the engagement portion 32 along the Y direction. The first lock arm 57 is arranged to enter between the pair of ribs 32a.

The first receiving portion 30 includes the three terminal receiving chambers 4 and three electric wire receiving portions 40 communicating with the respective three terminal receiving chambers 4. In the first receiving portion 30, the three terminal receiving chambers 4 correspond to spaces above the inner walls 37 (described later) in the Y direction, and the electric wire receiving portions 40 correspond to spaces below the inner walls 37. In a state in which the terminal clamps 2 and the electric wires 10 are received inside of the respective terminal receiving chambers 4, the thermosetting liquid silicone 8 which hardens by heat is injected into the respective terminal receiving chambers 4. This liquid silicone 8 corresponds to “a filler in molten state” described in claims.

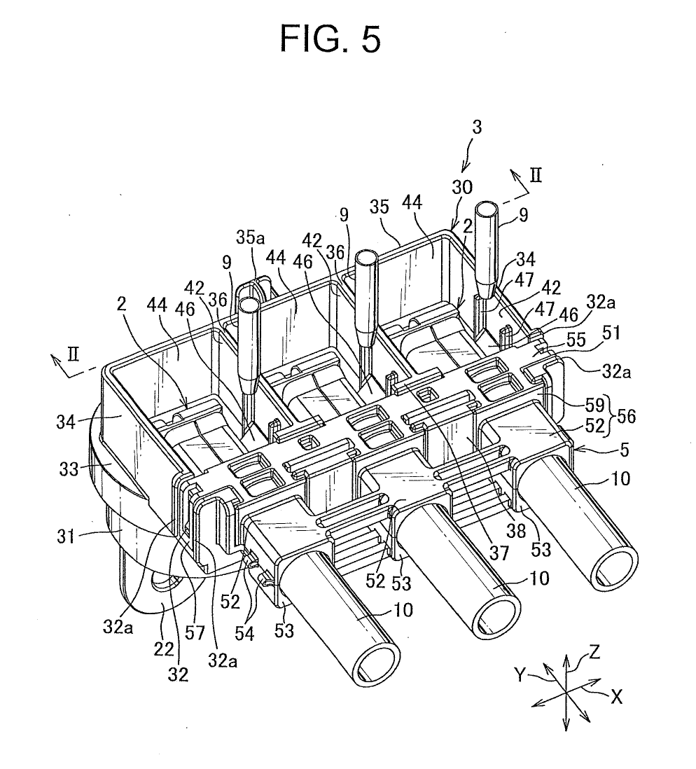

The three terminal receiving chambers 4 are aligned in the radial direction of the electric wire 10 (i.e. the X direction). The respective terminal receiving chambers 4 are formed into a box-like shape and having an opening 4a on one side in the Z direction. This opening 4a of the terminal receiving chamber 4 is a part of the opening 3a of the above-described first receiving portion 30. The terminal receiving portion 4 includes a rectangular bottom wall 41 located on the opposite side of the opening 4a, a first side face 42 formed continuously from an edge of the bottom face 41 in the widthwise direction (i.e. the X direction) and formed toward the opening 4a, a second side face 43 formed continuously from the edge of the bottom face 41 in the widthwise direction toward the opening 4a and located on the opposite side of the first side face 42, an upper face 44 (shown in FIG. 5) arranged to intersect with an opposing direction of the first side face 42 and the second side face 43 and formed continuously from an edge of the bottom face 41 toward the opening 4a, and a lead-out opening located on the opposite side of the upper face 44 and arranged to lead out the other end side of the electric wire 10. In other words, the lead-out opening is provided in a direction (i.e. the Y direction) intersecting with the opposing direction of the first side face 42 and the second side face 43.

Furthermore, as shown in FIG. 4, each of the terminal receiving chambers 4 includes a slanted face 46 formed at an intersection of the bottom face 41 and the first side face 42, i.e. at a corner of the terminal receiving chamber 4. The slanted face 46 is slanted in a direction away from the first side face 42 as extended toward the bottom face 41. The slanted face 46 is provided between the upper wall 35 and the inner wall 37 of the first receiving portion 30, i.e. at a central portion of the terminal receiving chamber 4 in the Y direction.

The bottom face 41 is provided on one side of the bottom wall 33 of the housing 3. The bottom face 41 includes a through-hole 41a (shown in FIG. 2) which penetrates through the bottom wall 33 of the housing 3 and into which the electric contact portion 22 of the terminal clamp 2 is inserted.

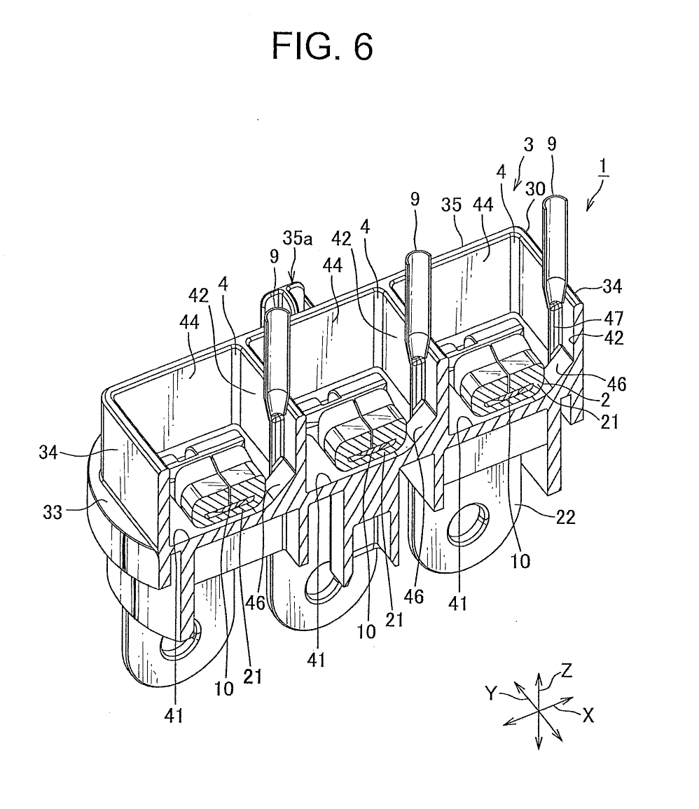

The first side faces 42 are faces on one side in the X direction (on the right hand side in FIG. 6) of one of the pair of side walls 34 of the first receiving portion 30 and of the respective two partition plates 36. The first side face 42 includes a pair of guide ribs 47 formed on both sides of the slanted face 46 of the terminal receiving chamber 4. The respective guide ribs 47 project from the first side face 42 and extend from the first bottom face 41 in the Y direction.

As shown in FIG. 4, the electric wire receiving portion 40 includes a recessed groove 40a formed on one surface in the Z direction. This recessed groove 40a has an inner face formed into a curved face on which a surface of the electric wire 10 is placed and is linearly extending in the Y direction. In addition, the electric wire receiving portions 40 are arranged at an interval along the X direction such that a second lock arm 58 (described later) of the rear holder 5 enters between the adjacent electric wire receiving portions 40 and engages with a second lock projection (not shown).

As shown in FIG. 3, the second receiving portion 31 is shaped into a tube having the opening 3b located on the opposite side of the opening 3a of the first receiving portion 30, i.e. on the other side in the Z direction. This second receiving portion 31 extends perpendicularly from the other side of the bottom wall 33. Furthermore, an engagement hole 31a is formed on an upper end of the second receiving portion 31 in the Y direction so as to penetrate through the second receiving portion 31. The engagement hole 31a is arranged to engage with an engagement portion 72 (described later) of the front holder 7.

As shown in FIG. 3, the rear holder 5 includes a holder body 51, a second holding portion 53 arranged to hold the electric wire 10 between the second holding portion 53 and a first holding portion 52 (described later) of the holder body 51, and a hinge 54 coupling the first holding portion 52 and the second holding portion 53.

The holder body 51 includes a rectangular base plate 55, three electric wire pushing portions 56 arranged at an interval in a longitudinal direction of the base plate 55 (i.e. the X direction) and arranged to project from a surface of the base plate 55 on the other side in the Z direction, the pair of first lock arms 57 extending perpendicularly from both ends of the base plate 55 in the longitudinal direction toward the other side and formed so as to elastically deform in the X direction, two second lock arms 58 extending perpendicularly from portions of the base plate 55 between the three electric wire pushing portions 56 toward the other side and formed so as to elastically deform in the Y direction. The lock arms 57, 58 are provided on an upper end of the holder body 51 in the Y direction and aligned in a line along the X direction.

The electric wire pushing portion 56 integrally includes a cover portion 59 arranged to cover the lead-out opening of the terminal receiving chamber 4 and a first holding portion 52 formed continuously from the cover portion 59 downwardly in the Y direction. The electric wire pushing portion 56 includes a recessed portion 51a formed on the other side of the electric wire pushing portion 56, and the recessed portion 51a is extending linearly in the Y direction. In other words, the recessed portion 51a is formed on both of the cover portion 59 and the first holding portion 52.

As shown in FIG. 3, the shield body 6 includes a tubular braided wire 61 arranged to cover the other end side of the electric wire 10, a plate-like shield shell 62 arranged to be attached to an end of the braided wire 61 and arranged to cover the opening 3a of the first receiving portion 30, and a shield ring 63 arranged to attach the braided wire 61 and the shield shell 62 to each other.

The braided wire 61 is formed by braiding element wires made of conductive metal material and such, for example. Furthermore, the braided wire 61 includes a large-diameter portion 61a having an inner diameter expanded to cover an outer periphery of the electric wire pass-through portion 69 (described later) of the shield shell 62.

The shield shell 62 is made of a conductive metal. As shown in FIGS. 2 and 3, the shield shell 62 includes a rectangular base wall 64 arranged to cover the opening 3a of the first receiving portion 30, a pair of side walls 65 extending perpendicularly from both ends of the base wall 64 in a longitudinal direction (i.e. the X direction) toward the housing 3, a first upper wall 66 connecting the pair of side walls 65 and extending perpendicularly from an end of the base wall 64 in the widthwise direction (i.e. the Y direction), a vertically-arranged wall 67 formed continuously from en end of the first upper wall 66 and arranged parallel to the base wall 64, a second upper wall 68 formed perpendicularly from an edge of the vertically-extending wall 67 and arranged parallel to the first upper wall 66, and a tubular electric wire pass-through portion 69 arranged on the opposite side of the first upper wall 66 and arranged to pass the other end side of the electric wire 10 through the electric wire pass-through portion 69. The vertically-arranged wall 67 includes the fitting hole 6a which penetrates through the vertically-arranged wall 67. The fitting portion 35a of the housing 3 is fitted in an engaged fashion in the fitting hole 6a.

As shown in FIG. 3, the front holder 7 includes an oval plate portion 70 arranged to cover the opening 3b of the second receiving portion 31, and a tubular peripheral plate 71 extending perpendicularly from a peripheral edge of the plate portion 70. The plate portion 70 includes a through-hole 70a through which the electric contact portion 22 of the terminal clamp 2 is inserted. The peripheral plate 71 includes an engagement portion 72 formed on an inner face of the peripheral plate 71 and arranged to enter into the engagement hole 31a of the second receiving portion 31.

Next, an assembly procedure of the above-described connector 1 is explained with reference to FIGS. 5-7. Firstly, in advance, the electric wire 10 and the terminal clamp 2 are connected to each other, the other end side of the electric wire 10 is passed into the large-diameter portion 61a of the braided wire 61 of the shield body 6, the electric wire pass-through portion 69 of the shield shell 62 is covered with the large-diameter portion 61a, and the braided wire 61 is attached to the shield shell 62 using the shield ring 63 such that the terminal clamp 2 is located inside of the electric wire pass-through portion 69. Next, as shown in FIG. 5, the electric contact portion 22 of the terminal clamp 2 is passed through the pass-through hole 41a of the terminal receiving chamber 4, and the terminal clamp 2 is received in the terminal receiving chamber 4 and the respective electric wires 10 are received in the recessed groove 40a of the respective electric wire receiving portion 40. At this time, there is a gap formed between the electric wire connection portion 21 of the terminal clamp 2 and the first side face 42, the slated face 46, the bottom face 41 and the second side face 43 of the terminal receiving chamber 4. Thus, since the gap is formed between the terminal clamp 2 and the terminal receiving chamber 4, a passage through which the liquid silicone 8 is injected is formed between the terminal clamp 2 and the first side face 41, the slanted face 46, the bottom face 41 and the second side face 43.

Then, the rear holder 5 is moved closer to the respective electric wire receiving portion 40 of the first receiving portion 30 from the side of the respective electric wire pushing portion 56, and the respective cover portions 59 are pushed against the respective electric wire receiving portions 40, and the first lock arm 57 is engaged with the engagement portion 32 of the first receiving portion 30, and the second lock arms 58 are entered between the electric wire receiving portions 40 of the first receiving portion 30 and engaged with the second lock projections. The second holding portion 53 is pushed against the first holding portion 52 to sandwich the electric wire between the holding portions 52, 53 and to attach the holding portions 52, 53 to each other. In this way, the rear holder 5 is attached to the first receiving portion 30. The rear holder 5 closes the gap between the electric wire 10 and the lead-out opening of the terminal receiving chamber 4.

Next, as shown in FIG. 6, an injection hole of a tubular nozzle 9 is moved closer to a portion between the pair of guide ribs 47 from the opening 4a of the terminal receiving chamber 4, and the liquid silicone 8 is injected toward the slanted face 46. As shown in FIG. 7, the liquid silicone 8 passes through the passage and pushes the air existing in the gap between the terminal clamp 2 and the first side face 42, the slanted face 46 and the bottom face 41 of the terminal receiving chamber 4 out from the gap between the terminal clamp 2 and the second side face 43, so the liquid silicone 8 is injected in the gap between the terminal clamp 2 and the terminal receiving chamber 4. In such a manner, the air is not left in the gap between the terminal clamp 2 and the terminal receiving chamber 4, thereby preventing the formation of an air hole inside of the liquid silicone 8 and improving the air-tightness in the terminal receiving chamber 4. Also, there is no need to buy time to discharge the air existing in the gap between the terminal clamp 2 and the terminal receiving chamber 4, thus the speed of injection of the liquid silicone 8 can be increased and the manufacturing efficiency can be improved. In addition, the terminal clamp 2 includes the R portion 21a (i.e. the curved face) formed by chamfering a corner of the terminal clamp 2 located on the opposite side of the slanted face 46 of the terminal receiving chamber 4. Thus, the distance between the R portion 21a and the slanted face 46 is ensured, and the liquid silicone 8 can be injected unimpededly through the gap between the terminal clamp 2 and the terminal receiving chamber 4. Furthermore, by providing the rear holder 5, the gap between the lead-out opening of the terminal receiving chamber 4 and the electric wire 10 is closed, thereby preventing the liquid silicone 8 from leaking out of the terminal receiving chamber 4. In such a manner, the terminal receiving chamber 4 is filled with the liquid silicone 8. After that, the liquid silicone 8 inside of the terminal receiving chamber 4 is hardened by heating with a heater and such.

Next, the shield shell 62 attached to the braided wire 61 is moved closer to the first receiving portion 30 so as to cover the opening 3a of the first receiving portion, and the fitting portion 35a of the first receiving portion 30 is fitted in an engaged fashion in the fitting hole 6a to attach the shield body 6 to the first receiving portion 30. The shield body 6 serves to electrically-shield the electric wire 10. Finally, the front holder 7 is attached to the second receiving portion 31 using a packing 73 by moving the plate portion 70 closer to cover the opening 3b of the second receiving portion 31 and by engaging the engagement portion 72 with the engagement hole 31a of the second receiving portion 31. In such a manner, the connector 1 is assembled.

As described above, since the connector 1 is provided with the shield body 6, the electrical noise is prevented from leaking out of the braided wire 61 from the electric wire 10. Moreover, since the terminal receiving chamber 4 is filled with the liquid silicone 8, the waterproof (i.e. water stop) performance of the connection portion of the terminal clamp 2 and the electric wire 10 can be provided as well.

The embodiments described above are only representative embodiments of the present invention, and the present invention is not limited to these embodiments. That is, the embodiments can be modified and performed in various ways without departing from the scope of the present invention.

### REFERENCE SIGNS LIST

1 connector
2 terminal clamp
3 housing
4 terminal receiving chamber
4a opening
41 bottom face
42 first side face
46 slanted face

1. A connector comprising
a terminal clamp arranged to connect with an electric wire, and
a housing arranged to receive the terminal clamp and the electric wire and including a box-like terminal receiving chamber having an opening, the terminal receiving chamber being filled with a filler, wherein
the terminal receiving chamber includes a bottom face located on opposite side of the opening and a first side face formed continuously from the bottom face toward the opening,
a slanted face is provided at an intersection of the bottom face and the first side face, the slanted face being slanted toward a direction further away from the first side face as extended toward the bottom face, and
a gap is formed between the terminal clamp and the first side face, the slanted face and the bottom face.

2. The connector according to claim 1, wherein
the terminal receiving chamber includes a second side face located on opposite side of the first side face and formed continuously from the bottom face toward the opening, and
a gap is formed between the terminal clamp and the second side face.

3. The connector according to claim 1,
wherein the terminal clamp includes
an electric wire connection portion arranged to connect with an one end of the electric wire and
an electric contact portion arranged to connect with a mating terminal clamp, the electric contact portion being bent at a portion between the electric wire connection portion and the electric contact portion,
wherein the terminal receiving chamber includes a through-hole formed on the bottom face for passing the electric contact portion through the through-hole, and a lead-out opening provided in a direction intersecting with an opposing direction of the first side face and the second side face to lead out the other end side of the electric wire, and
wherein the connector includes a rear holder attached from the side of the opening of the terminal receiving chamber to close a gap between the lead-out opening and the electric wire.

4. The connector according to claim 2,
wherein the terminal clamp includes
an electric wire connection portion arranged to connect with an one end of the electric wire and
an electric contact portion arranged to connect with a mating terminal clamp, the electric contact portion being bent at a portion between the electric wire connection portion and the electric contact portion,
wherein the terminal receiving chamber includes a through-hole formed on the bottom face for passing the electric contact portion through the through-hole, and a lead-out opening provided in a direction intersecting with an opposing direction of the first side face and the second side face to lead out the other end side of the electric wire, and
wherein the connector includes a rear holder attached from the side of the opening of the terminal receiving chamber to close a gap between the lead-out opening and the electric wire.

5. The connector according to claim 1, wherein a corner of the terminal clamp located on opposite side of the slanted face is chamfered.

6. The connector according to claim 2, wherein a corner of the terminal clamp located on opposite side of the slanted face is chamfered.

7. The connector according to claim 3, wherein a corner of the terminal clamp located on opposite side of the slanted face is chamfered.

8. The connector according to claim 4, wherein a corner of the terminal clamp located on opposite side of the slanted face is chamfered.

9. A method for manufacturing the connector according to claim 1, the method comprising a step of injecting the filler in a molten state from the opening toward the slanted face.

10. A method for manufacturing the connector according to claim 2, the method comprising a step of injecting the filler in a molten state from the opening toward the slanted face.

11. A method for manufacturing the connector according to claim 3, the method comprising a step of injecting the filler in a molten state from the opening toward the slanted face.

12. A method for manufacturing the connector according to claim 4, the method comprising a step of injecting the filler in a molten state from the opening toward the slanted face.

13. A method for manufacturing the connector according to claim 5, the method comprising a step of injecting the filler in a molten state from the opening toward the slanted face.

14. A method for manufacturing the connector according to claim 6, the method comprising a step of injecting the filler in a molten state from the opening toward the slanted face.

15. A method for manufacturing the connector according to claim 7, the method comprising a step of injecting the filler in a molten state from the opening toward the slanted face.

16. A method for manufacturing the connector according to claim 8, the method comprising a step of injecting the filler in a molten state from the opening toward the slanted face.
